(19) United States
(12) Patent Application Publication
(10) Pub. No.: US 2006/0018314 A1
(43) Pub. Date: Jan. 26, 2006

(54) Method of downloading data from PC to PHS or vice versa

(75) Inventors: Cheng-Shing Lai, Taipei Hsien (TW); Jun-Sheng Zhang, Nanking (CN); Yong-Qian Gu, Nanking (CN)

Correspondence Address: BACON & THOMAS, PLLC, 625 SLATERS LANE, FOURTH FLOOR, ALEXANDRIA, VA, 22314, US

(73) Assignee: Inventec Appliances Corporation, Taipei Hsien (TW)

(21) Appl. No.: 10/893,959

(22) Filed: Jul. 20, 2004

(51) Int. Cl. H04L 12/56; H04L 12/28; H04J 3/00

(52) U.S. Cl. 370/389

(57) ABSTRACT

The present invention is to provide a method of downloading data from a PC to a PHS or vice versa, which comprises the steps of commanding a PC to edit data (e.g., phonebook, picture, or ring data) by a PHS, sending the edited data complying with the data requirements of the PHS to a data packet sending mechanism of the PC, and dividing the data into a plurality of data packets, sequentially sending the data packets to the PHS via a transfer interface of the PC, assembling the data packets for verification and storing the data packets in a corresponding area of the PHS.

### FIELD OF THE INVENTION

The present invention relates to PHSs (Personal Handyphone Systems) and more particularly to a method of downloading data from a PC (Personal Computer) to a PHS or vice versa with improved characteristics.

### BACKGROUND OF THE INVENTION

PHS, a low power cellular phone system, is gaining popularity recently due to technological advancements. Moreover, PHSs are promoted by major telephone companies. As a result, more and more people like to use PHSs. Conventionally, user data in the PHS is classified as either alphanumeric data (e.g., phonebook) or non-alphanumeric data (e.g., picture and ring).

Currently, alphanumeric data is keyed in a PHS by means of an input device thereof. This is not convenient in operation. Further, data copy is not possible. It is understood that phonebook is a very important feature of PHS. Also, phonebooks of almost all PHSs can be edited by itself rather than copying content of the phonebook or downloading content of an external phonebook into the PHS.

Moreover, non-alphanumeric data of PHS is fixed. That is, it is not permitted to alter pictures and rings. Except particular features such as picture taking and sound recording, the same background picture and ring are used by PHSs of the same type. Hence, a user has to be patient of using the same background picture and ring as others rather than downloading desired ring and pictures from a PC into a PHS owned by him/herself. Thus, a personalized PHS is made impossible. Hence, a need for improvement exists.

### SUMMARY OF THE INVENTION

An object of the present invention is to provide a method of updating and copying data (e.g., phonebook, pictures, or ring) of a PHS by means of a PC having a powerful data processing capability. By utilizing the present invention, a user can change a picture and ring of his/her PHS as desired so as to personalize the PHS. Further, by utilizing a data verification and resending mechanism of the present invention, data correctness can be ensured. As an end, all above drawbacks of the prior art can be overcome.

The above and other objects, features and advantages of the present invention will become apparent from the following detailed description taken with the accompanying drawings.

### BRIEF DESCRIPTION OF THE DRAWINGS

FIG. 1 is a flow chart illustrating a data packet sending process performed by a sending party according to the invention;

FIG. 2 is a flow chart illustrating a data packet receiving process performed by a receiving party according to the invention;

FIG. 3 is a flow chart illustrating a process performed by a PHS in response to a received phonebook downloading request from a PC according to the invention;

FIG. 4 is a flow chart illustrating a process performed by a PC in response to a received data packet from a PHS according to the invention;

FIG. 5 is a flow chart illustrating a process of downloading phonebook request from a PC to a PHS according-to the invention;

FIG. 6 is a flow chart illustrating a process of receiving a downloaded phonebook from a PC by a PHS according to the invention;

FIG. 7 is a flow chart illustrating a process showing a sequence of method steps performed by the invention prior to downloading pictures;

FIG. 8 is a flow chart illustrating a process showing a sequence of method steps performed by the invention prior to downloading ring;

FIG. 9 is a flow chart illustrating a process of sending picture or ring data from a PHS to a PC according to the invention; and

FIG. 10 is a flow chart illustrating a process of receiving sent picture or ring data from a PC by a PHS according to the invention.

### DETAILED DESCRIPTION OF THE PREFERRED EMBODIMENTS

The invention is directed to a method of downloading data from a PC to a PHS or vice versa. The method comprises the steps of commanding a PC to edit data (e.g., phonebook, picture, or ring data) by a PHS, sending the edited data complying with the data requirements of the PHS to a data packet sending mechanism, and dividing the data into a plurality of data packets, sequentially sending the data packets to the PHS via a transfer interface, assembling the data packets for verification, and storing the data packets in a corresponding area of the PHS or dividing the data in the PHS into a plurality of data packets having a predetermined length, sequentially sending the data packets to the PC via the transfer interface, and storing the data packets as a corresponding predetermined data document in the PC. In such a manner, it is possible of downloading data from the PC to the PHS or downloading data from the PHS to the PC as a copy.

In the invention, the data packet sending mechanism commands a sending party to send a data packet. Thereafter, the mechanism waits an ACK (affirmative acknowledgement) data packet replied from a receiving party after performing verification thereat. The sending party will send a next data packet or wait if the ACK data packet is correct. Alternatively, the sending party will send the previously sent data packet again if the ACK data packet is not correct. Moreover, the sending party will stop the sending if a correct ACK data packet has not been received after sending three times. Also, the sending party will a “sending failure” prompt to a user so that the user can check associated equipment and method steps prior to resuming the operation. In addition, if no reply from a receiving party has been received after the waiting time has reached a period of time set by a time-out control after the sending party has sent a data packet, the sending party will send the previously sent data packet again. Moreover, the sending party will stop the sending if a correct ACK data packet has not been received after sending three times. Also, the sending party will a “sending failure” prompt to a user so that the user can check associated equipment and method steps prior to resuming the operation.

In addition, after the PC has read data from the PHS and has found phonebook information therein, a user-may select a group, a plurality of groups, or the content of the phonebook to be downloaded from the PC based on the read phonebook information. Next, send the selected downloading data to the PHS. After receiving the data to be downloaded into the phonebook, the PHS will assemble all data complying with the downloading request of the phonebook into a data block. Next, divide the data block into a plurality of data packets having a predetermined length. Further, sequentially send the data packets to the PC via the transfer interface. Finally, the PC assembles the received data packets again prior to storing in a phonebook table thereof.

Additionally, a user may select a group, a plurality of groups, or the content of the phonebook to be downloaded from the PC based on the read phonebook information. Next, the PHS will assemble all data complying with the downloading request of the phonebook into a data block. Next, divide the data block into a plurality of data packets having a predetermined length. Further, sequentially send the data packets to the PHS via the transfer interface. Next, the PHS assembles the received data packets for verifying its completeness. Finally, the verified data packets are stored in a phonebook data area.

Moreover, in a case of data contained in the PC is picture or ring data to be downloaded, the PC converts the data into one complying with the PHS. Next, divide the data into a plurality of data packets having a predetermined length. Further, sequentially send the data packets to the PHS via the transfer interface. Next, the PHS assembles the received data packets for verifying its completeness. Finally, the verified data packets are stored in a corresponding data area thereof.

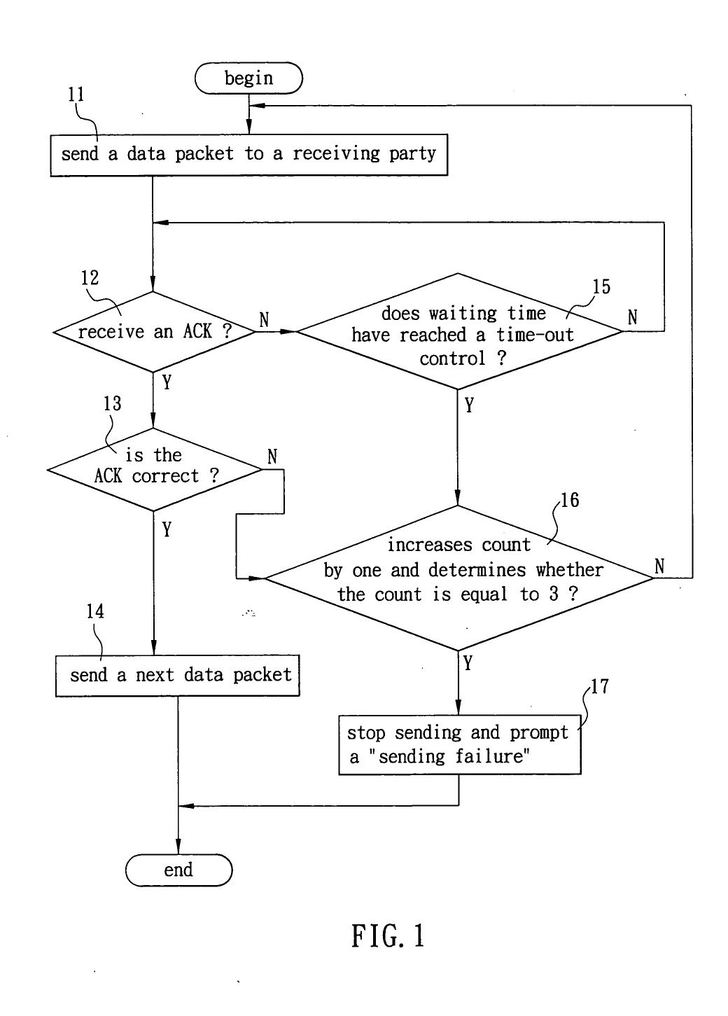

Referring to FIG. 1, there is shown a flow chart illustrating a data packet sending process performed by a sending party according to the invention.

In step 11, a sending party sends a data packet to a receiving party and the sending party waits a reply therefrom.

In step 12, it is determined whether an ACK from the receiving party has been received. If yes, the process goes to step 13. Otherwise, the process jumps to step 15.

In step 13, it is determined whether the received ACK is correct or not. If yes, the process goes to step 14. Otherwise, the process jumps to step 16.

In step 14, the sending party continues to send a next data packet to the receiving party and waits for reply. The process ends immediately.

In step 15, the sending party waits to receive an ACK from the receiving party and determines whether the waiting time has reached a time-out control. If yes, the process goes to step 16. Otherwise, the process loops back to step 12.

In step 16, the sending party increases count (i.e., count has an initial value of zero (0)) of the sent data packet by one (1) and determines whether the count is equal to three (3). If yes, the process goes to step 17. Otherwise, the process jumps to step 11.

In step 17, stop the data packet sending and show a “sending failure” prompt to a user so that the user can check associated equipment and method steps. The process ends immediately.

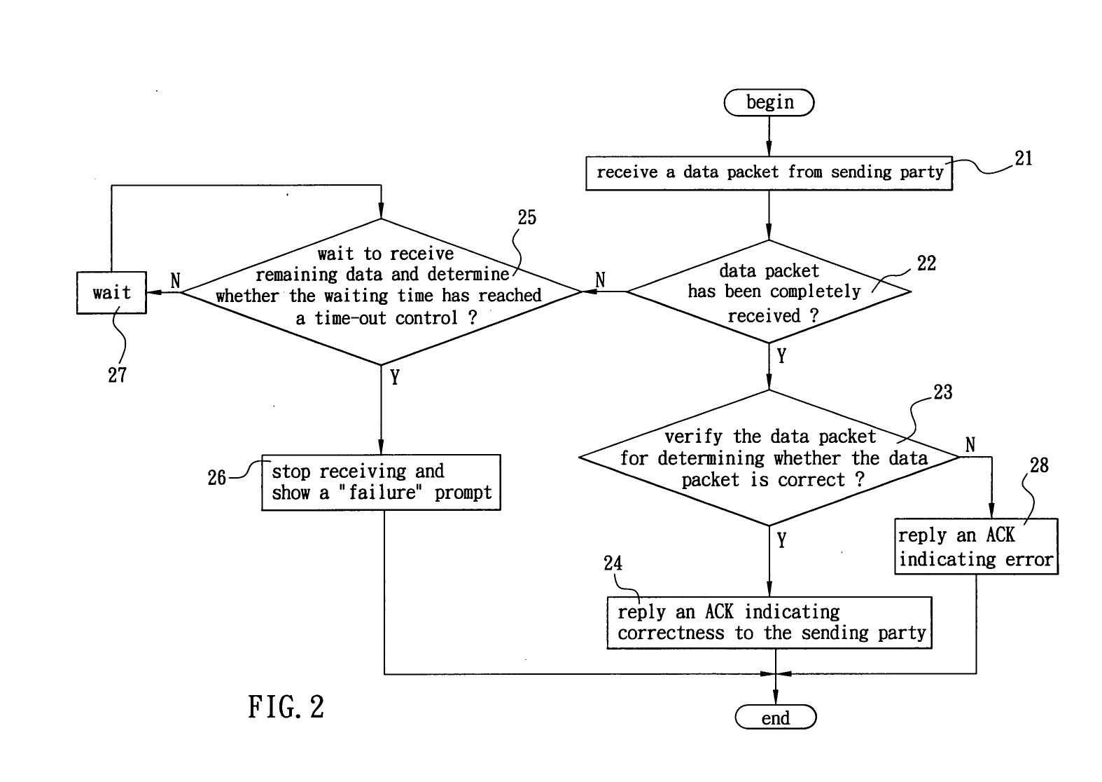

Referring to FIG. 2, there is shown a flow chart illustrating a data packet receiving process performed by a receiving party according to the invention.

In step 21, the receiving party receives a data packet from the sending party.

In step 22, it is determined whether data packet is completely received.

In step 23, verify the data packet in order to determines whether the data packet is correct. If yes, the process goes to step 24. Otherwise, the process jumps to step 28.

In step 24, reply an ACK indicating correctness to the sender and wait for a next data packet. The data packet receiving process ends immediately.

In step 25, wait to receive remaining data and determines whether the waiting time has reached a time-out control. If yes, the process goes to step 26. Otherwise, the process jumps to step 27.

In step 26, stop the data packet receiving and show a “receiving failure” prompt to a user so that the user can check associated equipment and steps. The data packet receiving process ends immediately.

In step 27, wait prior to looping back to step 25.

In step 28, reply an ACK indicating error prior to ending the data packet receiving process.

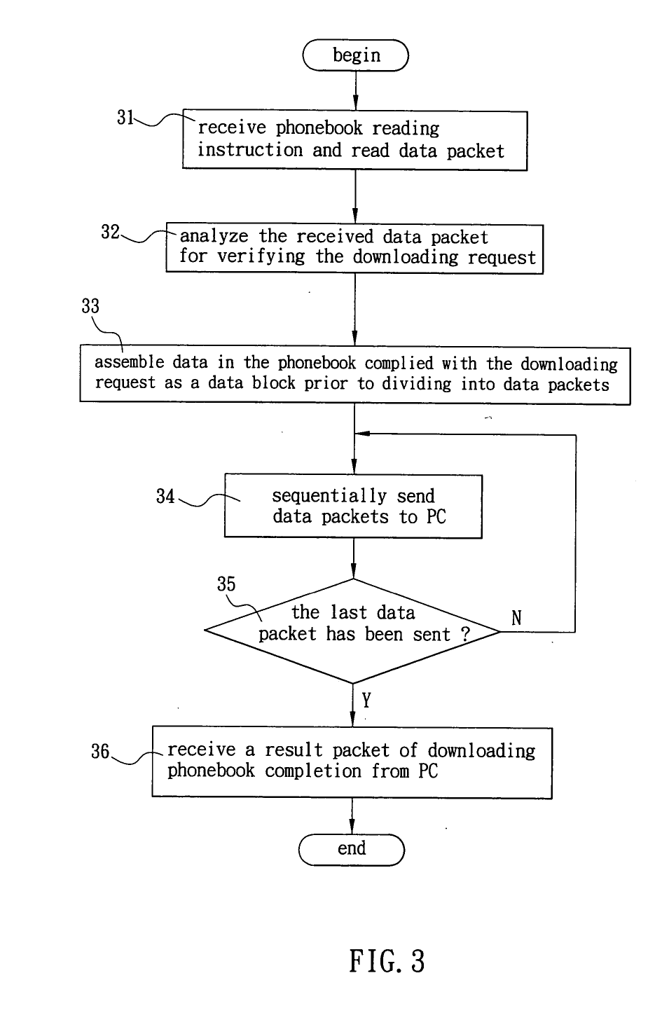

Referring to FIG. 3, there is shown a flow chart illustrating a process performed by a PHS in response to a received phonebook downloading request from a PC when the PHS is connecting to the PC.

In step 31, the PHS receives a request regarding a phonebook reading instruction and read data packet from the PC.

In step 32, analyze the received phonebook reading instruction and read data packet for verifying the downloading request.

In step 33, assemble all data in the phonebook complied with the downloading request as a data block and then divide the data block into a plurality of data packets having a predetermined length.

In step 34, sequentially send the data packets to the PC via a transfer interface.

In step 35, it is determined whether the last data packet has been sent. If yes, the process goes to step 36. Otherwise, the process loops back to step 34.

In step 36, receive a result packet of downloading phonebook completion from the PC. The downloading phonebook data packet process ends.

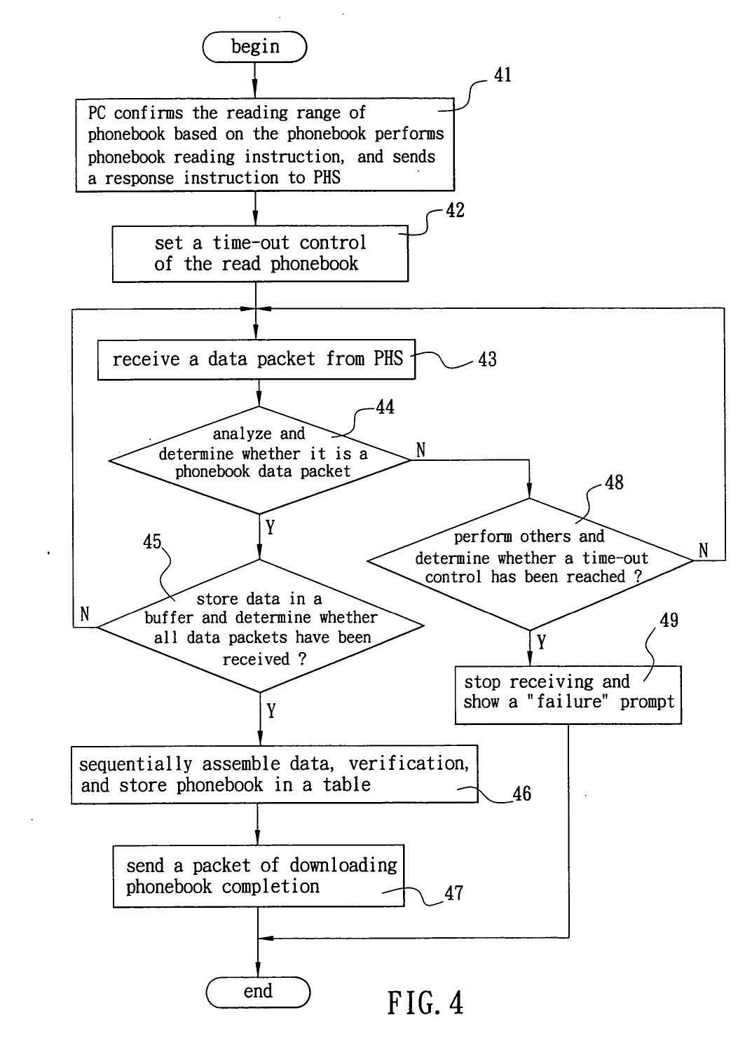

Referring to FIG. 4, there is shown a flow chart illustrating a process performed by a PC when a PHS is connecting to the PC in which the PC sends a downloading phonebook request to the PHS based on reading conditions selected by a user and the PC performs the following steps in response to a received data packet from the PHS.

In step 41, the PC confirms the reading range of phonebook based on the phonebook group selected by a user, performs the phonebook reading instruction, and sends a data packet regarding a response instruction and the reading range of phonebook to the PHS.

In step 42, set a time-out control of the read phonebook.

In step 43, receive a data packet sent from the PHS.

In step 44, analyze the data packet for determining whether it is a phonebook data packet or not. If yes, the process goes to step 45. Otherwise, the process jumps to step 48.

In step 45, store the phonebook data packet in a buffer and determine whether all data packets have been received. If yes, the process goes to step 46. Otherwise, the process loops back to step 43.

In step 46, sequentially assemble the receive data packets. After verifying the assembled receive data packets, store the content of phonebook in a table thereof.

In step 47, send a result packet of downloading phonebook completion. The downloading phonebook data packet process ends.

In step 48, perform other tasks and determine whether a time-out control has been reached. If yes, the process goes to step 49. Otherwise, the process loops back to step 43.

In step 49, stop the data packet sending and show a “sending failure” prompt to a user. The downloading phonebook data packet process ends immediately.

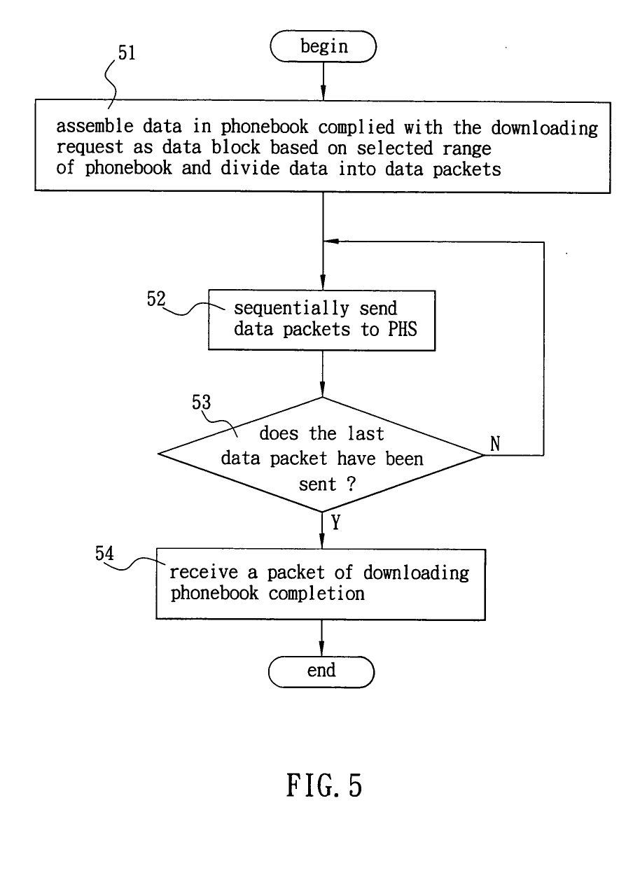

Referring to FIG. 5, there is shown a flow chart illustrating a process of downloading phonebook request from a PC to a PHS based on the selected range of phonebook by a user when the PHS is connecting to the PC.

In step 51, assemble all data in the phonebook complied with the downloading request as a data block based on the selected range of phonebook (e.g., a group, a plurality of groups, or the content of phonebook) by a user and then divide the data block into a plurality of data packets having a predetermined length.

In step 52, sequentially send the data packets to the PHS.

In step 53, it is determined whether the last data packet has been sent. If yes, the process goes to step 54. Otherwise, the process loops back to step 52.

In step 54, receive a result packet of downloading phonebook completion from the PHS. The downloading phonebook data packet process ends.

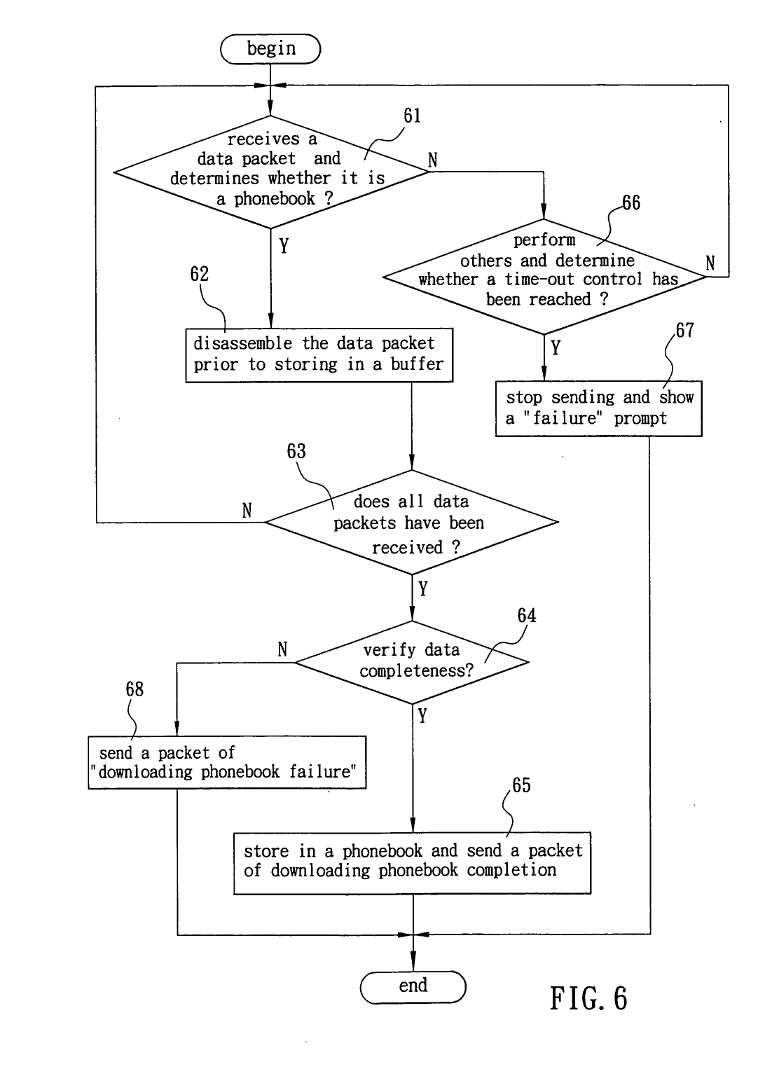

Referring to FIG. 6, there is shown a flow chart illustrating a process of receiving a downloaded phonebook from a PC by a PHS when the PHS is connecting to the PC.

In step 61, the PHS receives a data packet from the PC and determines whether the data packet is a phonebook. If yes, the process goes to step 62. Otherwise, the process jumps to step 66.

In step 62, disassemble the data packet prior to storing in a buffer.

In step 63, it is determined whether all data packets have been received. If yes, the process goes to step 64. Otherwise, the process loops back to step 61.

In step 64, sequentially assemble the received data packets for verifying its completeness. If yes, the process goes to step 65. Otherwise, the process jumps to step 68.

In step 65, store it in a phonebook and send a result packet of downloading phonebook completion. The downloading phonebook data packet process ends.

In step 66, perform other tasks and determine whether a time-out control has been reached. If yes, the process goes to step 67. Otherwise, the process loops back to step 61.

In step 67, stop the data packet sending and show a “sending failure” prompt to a user. The downloading phonebook data packet process ends immediately.

In step 68, send a result packet regarding “sending downloaded phonebook failure”. The downloading phonebook data packet process ends immediately.

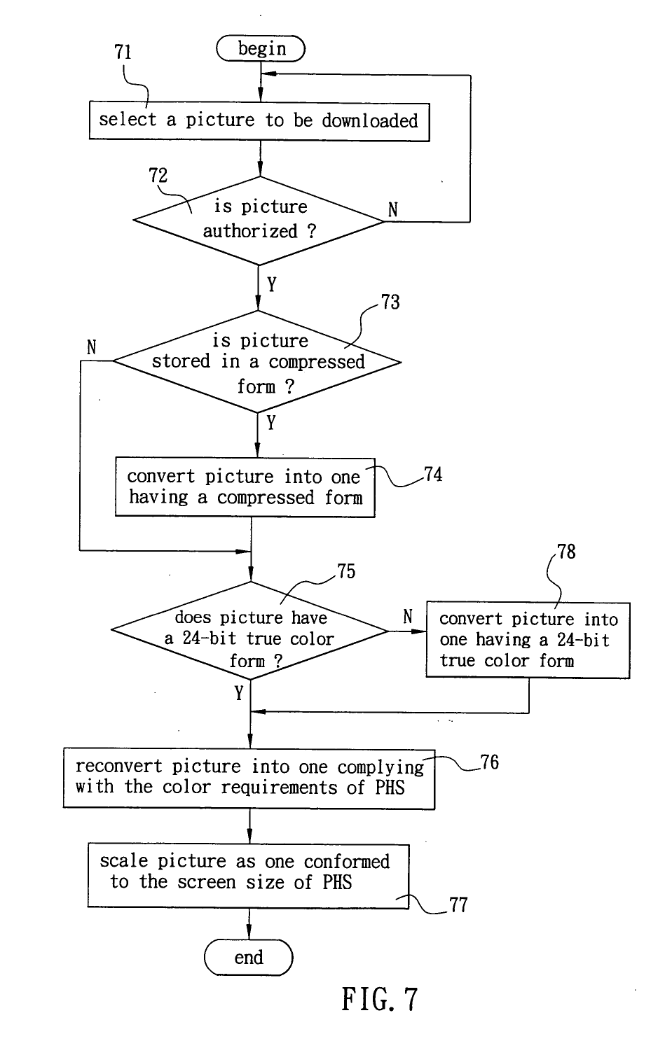

Referring to FIG. 7, there is shown a flow chart illustrating a process showing a sequence of method steps performed by a PHS and a PC according to the invention prior to downloading pictures.

In step 71, select a picture to be downloaded.

In step 72, it is determined whether the picture is authorized. If yes, the process goes to step 73. Otherwise, the process loops back to step 71.

In step 73, it is determined whether the picture is stored in a compressed form. If yes, the process goes to step 74. Otherwise, the process jumps to step 75.

In step 74, convert the picture into one having a compressed form.

In step 75, it is determined whether the picture has a 24-bit true color form. If yes, the process goes to step 76. Otherwise, the process jumps to step 78.

In step 76, reconvert the converted picture into one complying with the color requirements of the PHS.

In step 77, scale the picture as one conformed to the screen size of the PHS. The downloading picture preparations are completed.

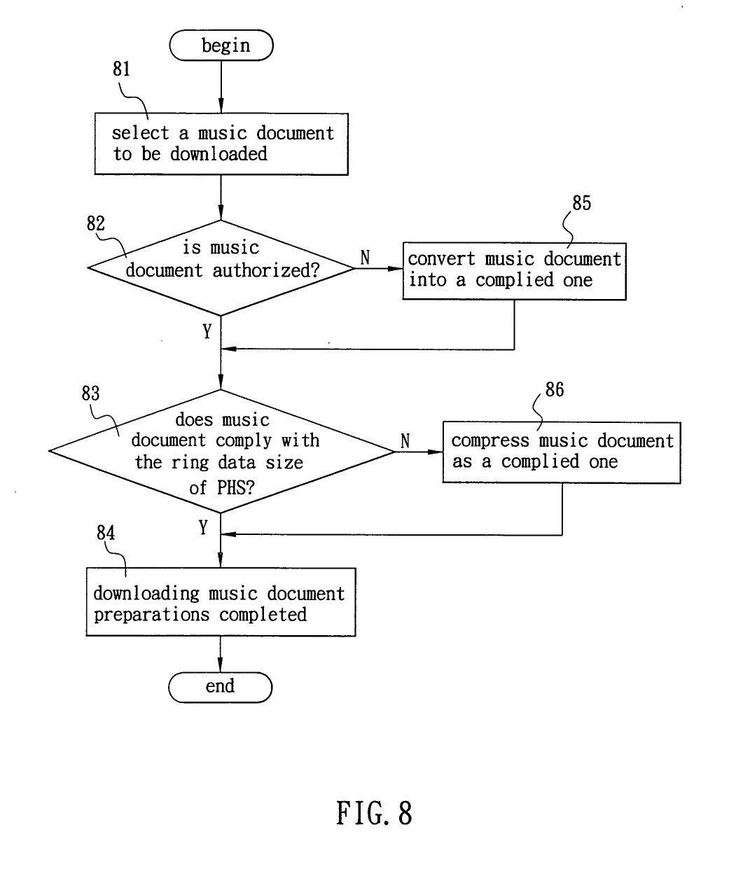

In step 78, convert the picture into one having a 24-bit true color form prior to looping back to step 76. Referring to FIG. 8, there is shown a flow chart illustrating a process showing a sequence of method steps performed by a PHS and a PC according to the invention prior to downloading ring data.

In step 81, select a music document to be downloaded.

In step 82, it is determined whether the music document is authorized. If yes, the process goes to step 83. Otherwise, the process jumps to step 85.

In step 83, it is determined whether the music document complies with the ring data size of the PHS. If yes, the process goes to step 84. Otherwise, the process jumps to step 86.

In step 84, the downloading music document preparations are completed prior to ending the process.

In step 85, convert the music document into one complying with the required format prior to looping back to step 83.

In step 86, compress the ring data of the music document as one complying with the requirements of the PHS prior to looping back to step 84.

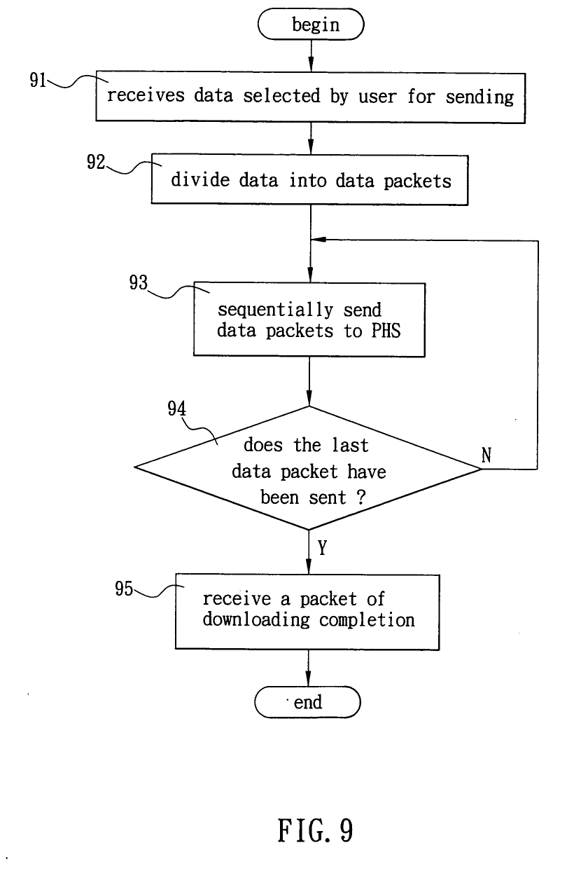

Referring to FIG. 9, there is shown a flow chart illustrating a process of sending picture or ring data from a PHS to a PC according to the invention.

In step 91, the PC receives picture or ring data which is selected by a user for sending.

In step 92, divide the picture or ring data into a plurality of data packets having a predetermined length.

In step 93, sequentially send the data packets to the PHS via a transfer interface.

In step 94, it is determined whether the last data packet has been sent. If yes, the process goes to step 95. Otherwise, the process loops back to step 93.

In step 95, receive a result packet of downloading completion prior to ending the picture or ring data packet downloading process.

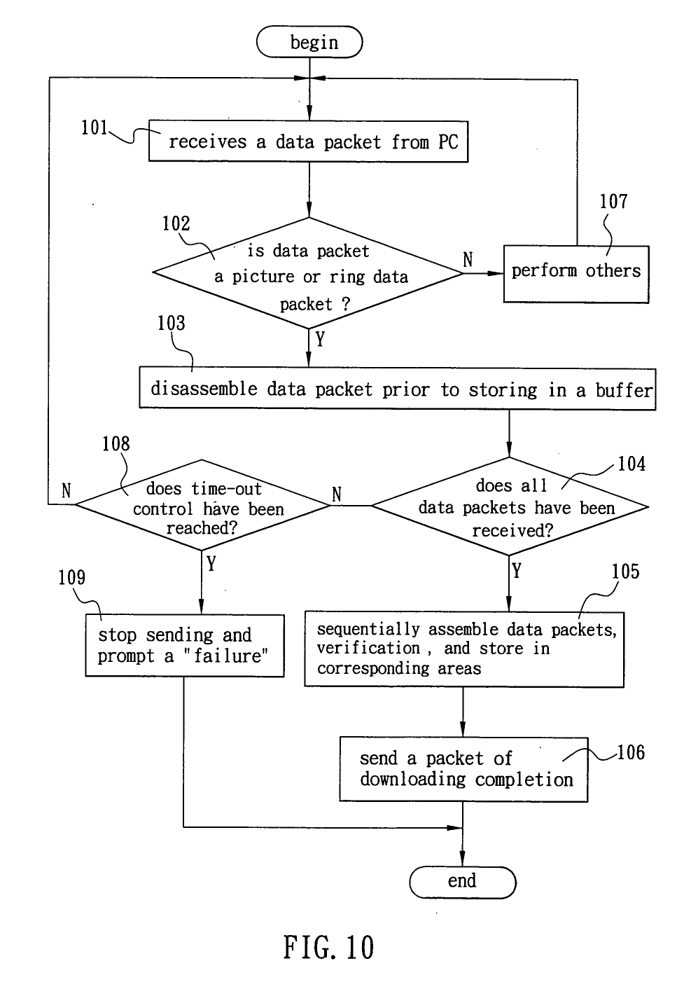

Referring to FIG. 10, there is shown a flow chart illustrating a process of receiving a sent picture or ring data packet from a PC by a PHS when the PHS is connecting to the PC.

In step 101, the PHS receives a data packet from the PC.

In step 102, it is determined whether the data packet is a picture or ring data packet. If yes, the process goes to step 103. Otherwise, the process jumps to step 107.

In step 103, disassemble the data packet prior to storing in a buffer.

In step 104, it is determined whether all data packets have been received. If yes, the process goes to step 105. Otherwise, the process jumps to step 108.

In step 105, sequentially assemble the received data packets for verifying its completeness prior to storing the same in corresponding areas based on types of thereof.

In step 106, send a result packet of downloading completion prior to ending the data packet downloading process.

In step 107, perform other tasks prior to looping back to step 101.

In step 108, it is determined whether a time-out control has been reached. If yes, the process goes to step 109. Otherwise, the process loops back to step 101.

In step 109, stop the data packet sending and show a “sending failure” prompt to a user. The data packet downloading process ends immediately.

While the invention has been described by means of specific embodiments, numerous modifications and variations could be made thereto by those skilled in the art without departing from the scope and spirit of the invention set forth in the claims.

What is claimed is:

1. A method of downloading data from a PC to a PHS or vice versa, comprising the steps of:
commanding said PC to edit data by said PHS;
sending the edited data complying with the data requirements of said PHS to a data packet sending mechanism of said PC; and
dividing the data into a plurality of data packets by said data packet sending mechanism and sequentially sending the data packets to the PHS via a transfer interface of said PC, assembling the data packets for verification and storing the data packets in a corresponding area of said PHS, or
dividing the data in said PHS into a plurality of data packets having a predetermined length, sequentially sending the data packets to said PC via said transfer interface, and storing the data packets as a corresponding predetermined data document in said PC so that it is possible of downloading data from the PC to the PHS or downloading data from the PHS to the PC as a copy.

2. The method of claim 1, wherein the data is phonebook, picture, or ring data.

3. The method of claim 1, wherein said data packet sending mechanism performs the steps of:
commanding a sending party to send a data packet;
waiting an ACK data packet reply from a receiving party after performing a verification thereat; and
commanding said sending party to send a next data packet or wait if the ACK data packet is correct.

4. The method of claim 3, wherein responsive to the ACK data packet being not correct, said sending party performs the steps of sending the previously sent data packet again, and stopping the sending if a correct ACK data packet has not been received after sending a predetermined times, and showing a failure prompt to a user so that the user can check associated equipment and the steps prior to resuming.

5. The method of claim 3, wherein if no reply from said receiving party has been received after a period of time set by a time-out control has lapsed after said sending party has sent the data packet, said sending party sends the previously sent data packet again.
